(19) United States
(12) Patent Application Publication
(10) Pub. No.: US 2016/0127428 A1
(43) Pub. Date: May 5, 2016

(54) Data Collaboration in an Enterprise Environment

(71) Applicants: Valentin Flunkert, Berlin (DE); Peter Hoffmann, Berlin (DE)

(72) Inventors: Valentin Flunkert, Berlin (DE); Peter Hoffmann, Berlin (DE)

(21) Appl. No.: 14/532,254

(22) Filed: Nov. 4, 2014

(51) Int. Cl. H04L 29/06; G06F 3/0484; G06F 3/0482; H04L 29/08

(52) U.S. Cl. CPC H04L 65/403; H04L 67/141; G06F 3/04842; G06F 3/0482

(57) ABSTRACT

Example embodiments involve a system, computer-readable storage medium storing at least one program, and computer-implemented method for data collaboration in an enterprise environment. The method may include establishing a collaboration session to facilitate editing of a data record accessed by at least two client devices. The method further includes providing instructions to the at least two client devices that cause display of an editable representation of the data record, and modifying the editable representation of the data record in accordance with received user edits. The method further includes preventing further modification to the editable representation in response to receiving a freeze request. The method may further include writing data representative of the editable representation to a persistent storage repository in response to receiving a commit request.

### TECHNICAL FIELD

Example embodiments of the present application generally relate to data processing and, more particularly, to data collaboration in an enterprise environment.

### BACKGROUND

Enterprise applications often face difficulty in managing concurrent editing of data by multiple different users. Traditional approaches to this challenge involve locking data when one user begins to edit the data. The usual locking mechanisms employed are either pessimistic locking or optimistic locking. However, each of these mechanisms presents additional challenges with regard to concurrent data editing. For example, in pessimistic locking, only one user is allowed to change a dataset at a given time, and all other users are prevented from writing to the data during the period when the active user is editing the data. The disadvantage of pessimistic locking is that multiple users are unable to edit the same dataset at the same time, even if their changes are independent of one another.

In optimistic locking, it is assumed that the data is not modified either during the time when the data is read from the database and presented to the user, or when a user stores updated data. If data is modified during one of these periods, the user receives an error message when he tries to store the data. Although optimistic locking allows users to edit data concurrently, when two users try to save their changes, they may discover that the data has already been modified and their changes may be obsolete.

### BRIEF DESCRIPTION OF THE DRAWINGS

Various ones of the appended drawings merely illustrate example embodiments of the present disclosure and cannot be considered as limiting its scope.

FIG. 1 is an architecture diagram illustrating a collaboration platform in an enterprise environment having a client-server architecture configured for exchanging data over a network, according to an example embodiment.

FIG. 2 is a data flow diagram illustrating example exchanges between various functional components of the enterprise environment during a collaboration session, according to an example embodiment.

FIGS. 3A-B are interaction diagrams illustrating example exchanges between various functional components of the enterprise environment, according to an example embodiment.

FIG. 4 is a block diagram illustrating various functional components of a data collaboration engine, which is provided as part of the collaboration platform, according to an example embodiment.

FIG. 5 is a flow chart illustrating a method for managing coincidental collaboration of a data record, according to an example embodiment.

FIG. 6 is a flow chart illustrating a method for synchronizing a model view of a data record involved in a collaboration session, according to an example embodiment.

FIG. 7 is a flow chart illustrating a method for synchronizing a model view of a data record involved in a collaboration session, according to an example embodiment.

FIG. 8A-B are interface diagrams illustrating an example collaboration interface and associated functionality, according to an example embodiment.

FIG. 9 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure involve systems and methods for maintaining data consistency while enabling real-time collaboration between multiple users. In example embodiments, multiple users may engage in a collaboration session involving one or more data records. For purposes of this disclosure, a “collaboration session” refers to the period of time in which at least two users (referred to as “collaborating users”) are concurrently engaged in browsing, creating, editing, deleting or otherwise manipulating at least one data record. For purposes of this disclosure, the term “data record” may refer to any item of stored information. For example, the term “data record” may be used to generally refer to a document or table stored in a database, or may be used to specifically refer to a field, member, or element of such a document or table.

Consistent with some embodiments, users involved in a collaboration session may be provided with an indication of other collaborating users, and a real-time view of the changes being made by the other collaborating users. In addition, collaboration interfaces provided as part of a collaboration session may enable users to communicate by real-time chat. In this way, communication overhead may be reduced because collaborating users are able to see who else is collaborating on data and the changes that are being made to the data in real-time all while communicating in real-time with other collaborators.

The data records involved in a collaboration session may be maintained in a persistent storage repository (e.g., a database), consistent with some embodiments. Users are not presented with the actual data record during a collaboration session. Instead, what is presented to users for collaboration is actually a model view of the data record stored in an intermediate storage repository of an application server. The model view is an intermediate copy of the data record that is stored in a format that may be rendered for presentation to the collaborating users. In this way, the users may freely edit information without, at least initially, affecting the persistent data record. Further, at any point during the collaboration session, users may “freeze” the data such that no users can modify the model view of the data record. The actual data record is not modified until a collaborating user selects to “commit” the data, at which time a new data record is written, or the existing data record is modified in accordance with the committed information. In the case of a new record being created, real-time collaboration is possible once all entries that uniquely identify the record (e.g. the customer name for a customer record) have been entered. From this point on, another user can be connected to this collaboration session, even before the new record has been persisted to the database. Accordingly, the systems and methods presented herein may provide the technical effect of reducing communication overhead during real-time collaboration sessions.

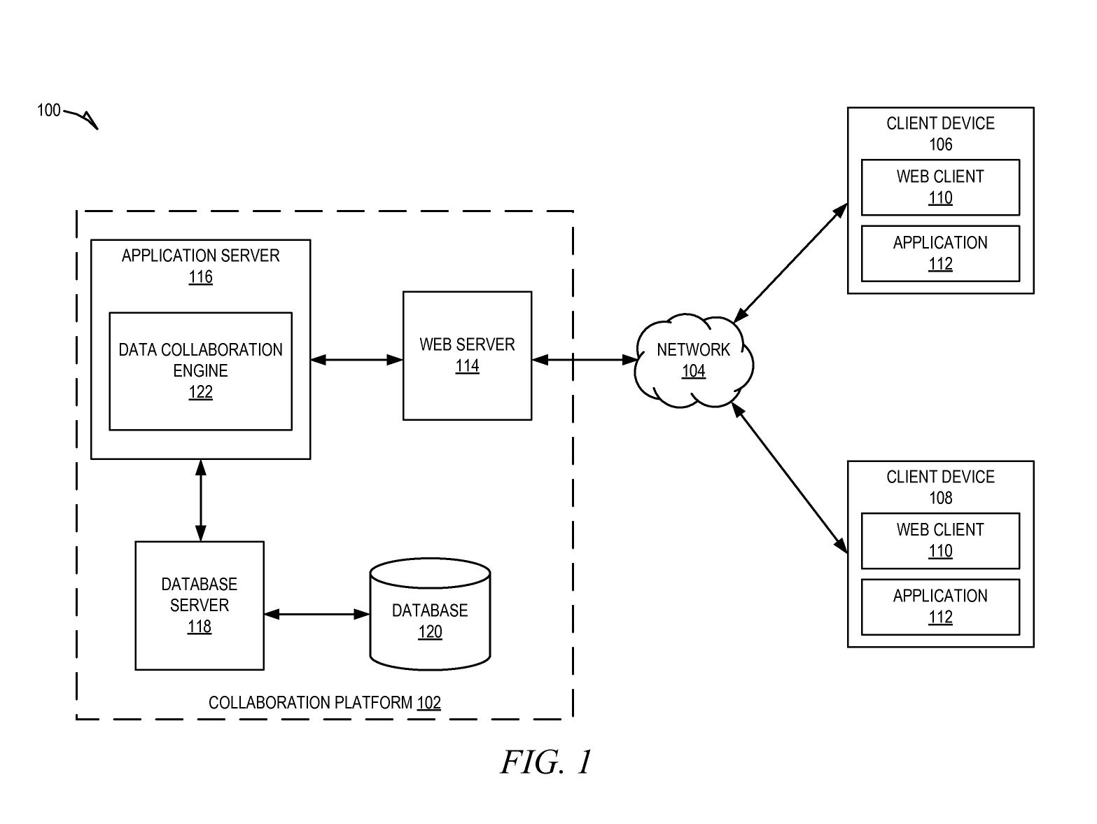

FIG. 1 is an architecture diagram illustrating a collaboration platform 102 in an enterprise environment 100 having a client-server architecture configured for exchanging data over a network 104, according to an example embodiment. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the enterprise environment 100 to facilitate additional functionality that is not specifically described herein.

As shown, the enterprise environment 100 includes a collaboration platform 102 in communication with client devices 106 and 108 over the network 104. The collaboration platform 102 and client devices 106 and 108 may connect to the network 104 through a variety of different mechanisms. For example, in some instances, the collaboration platform 102 and client devices 106 and 108 may connect to the network 104 via a Wireless Fidelity (Wi-Fi, IEEE 802.11x type) connection, a Worldwide Interoperability for Microwave Access (WiMAX) connection, or another type of wireless data connection. In such an embodiment, the network 104 may include one or more wireless access points coupled to a local area network (LAN), a WAN, the Internet, or other packet-switched data network. In other instances, the connection to the network 104 may be a wired connection, for example an Ethernet link, and the network 104 may be a LAN, a WAN, the Internet, or other packet-switched data network.

As illustrated in FIG. 1, client devices 106 and 108 may be executing a web client 110 (e.g., a web browser) or an application 112 to access, exchange, modify and exchange data with the collaboration platform 102. The application 112 may, for example, be an application specifically designed for interacting with various components of the enterprise environment 100.

Turning specifically to the collaboration platform 102, a web server 114 provides the client devices 106 and 108 with programmatic and web interfaces to an application server 116. The application server 116 may be coupled via the web server 114 to the network 104 using wired or wireless interfaces. The application server 116 is also illustrated in FIG. 1 as being coupled to a database server 118 that facilitates access to a database 120. The database 120, which may include a collection of databases that are external and internal to the enterprise environment 100, is a persistent data storage repository that stores and maintains a number of data records pertaining to aspects and functions of the enterprise environment 100 among other types of information. In some embodiments, the application server 116 may access the database 120 without the need for the database server 118.

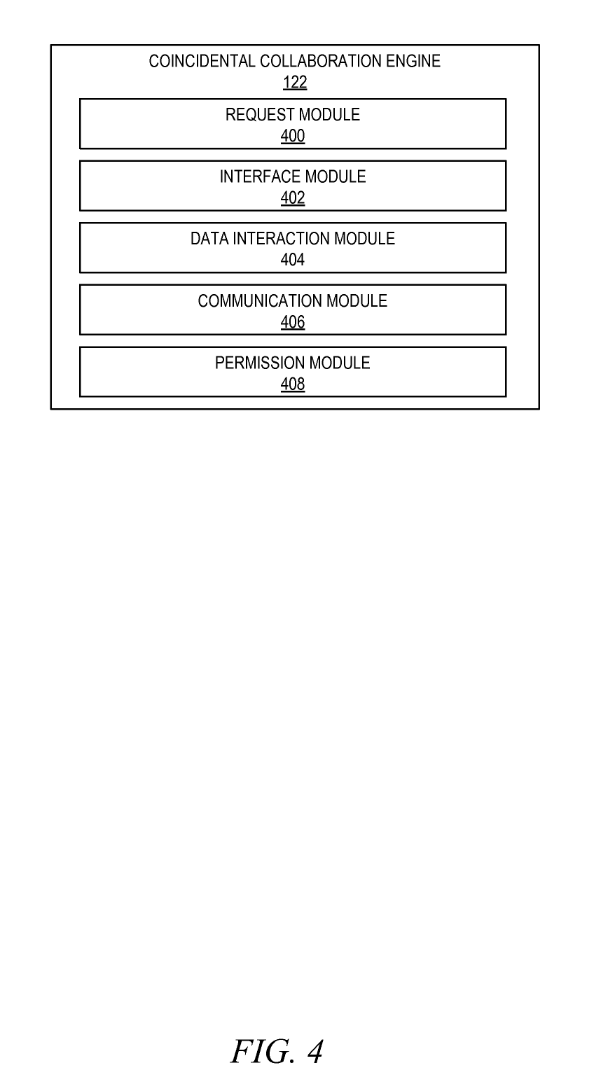

The application server 116 may, for example, host one or more applications to provide tools and services to users of the enterprise environment 100. As shown, the application server 116 hosts a data collaboration engine 122, which may be integrated with any one of the applications hosted by the application server 116. The data collaboration engine 122 facilitates collaboration sessions between users of the enterprise environment 100 so as to allow multiple users to concurrently access, write, add, modify, destroy or otherwise manipulate data records to the database 120. Further details regarding the functional components forming the data collaboration engine 122 are discussed below with reference to FIG. 4.

Although the data collaboration engine 122 has been discussed and is illustrated as being an independent service that is integrated as part of the collaboration platform 102, it shall be appreciated that, in alternative embodiments, the data collaboration engine 122 may form part of or be integrated with any other services or applications that may be provided by the enterprise environment 100. Further, the data collaboration engine 122 may form part of a service that is separate and distinct from the collaboration platform 102 and the enterprise environment 100.

While the enterprise environment 100 shown in FIG. 1 employs client-server architecture, the present inventive subject matter is, of course, not limited to such an architecture, and could equally well find application in an event-driven, distributed, or peer-to-peer architecture system, for example. Further, the various functional components of the collaboration platform 102 may be implemented as standalone systems or software programs, which do not necessarily have networking capabilities. Moreover, it shall be appreciated that although the various functional components of the enterprise environment 100 are discussed in the singular sense, multiple instances of one or more of the various functional components may be employed.

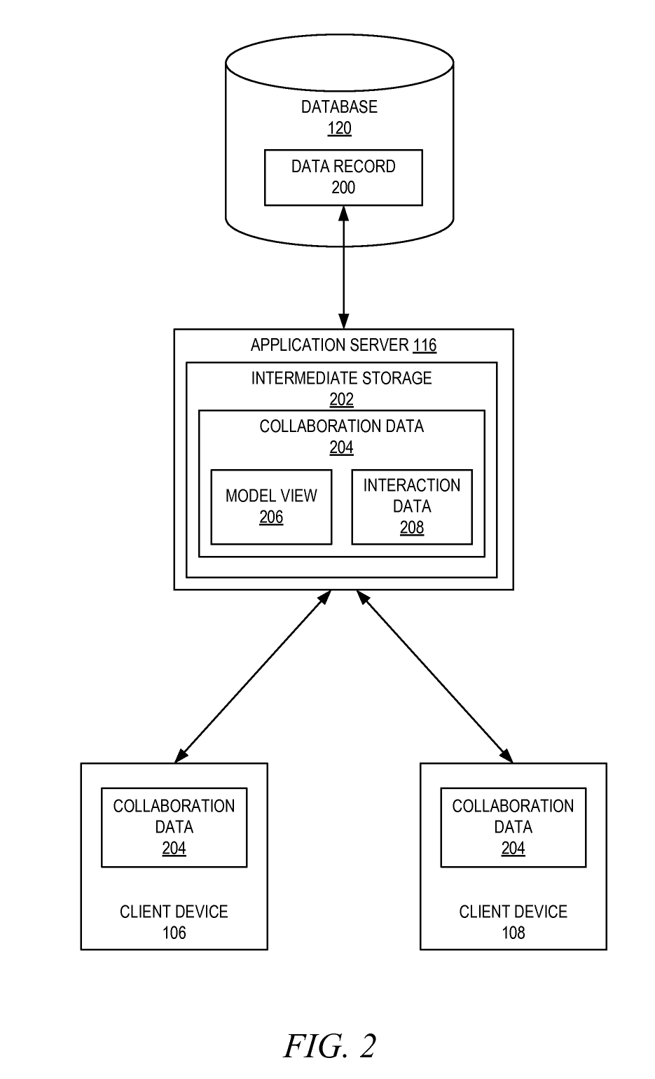

FIG. 2 is a data flow diagram illustrating example exchanges various functional components of the enterprise environment 100 during a collaboration session, according to an example embodiment. More specifically, FIG. 2 illustrates the client devices 106 and 108 engaged in a collaboration session involving a data record 200 stored in the database 120. Upon receiving concurrent requests to access the data record 200 from the client devices 106 and 108, the application server 116 establishes the collaboration session, which includes establishing a real-time communication link between the client devices 106 and 108. The requests received by the application server 116 are concurrent in the sense that they are received at the same time, substantially the same time, or that one request to access the data record 200 is received from one of the devices 106, 108 while the other device 106, 108 is accessing the data record 200.

In facilitating the collaboration session between the client devices 104 and 106, the application server 116 collects and maintains collaboration data 204 in an intermediate storage 202, which is a non-permanent or volatile memory component of the application server 116 such as random access memory (RAM). The collaboration data 204 is comprised of a model view 206 and interaction data 208. The model view 206 is an intermediate copy of the data record 200 that provides an editable visual representation of the current state of the data record 200. The interaction data 208 includes a list of collaborating users, mouse positions of the collaborating users, chat related information, and the state of various user interface (UI) elements provided as part of various graphical user interfaces (GUIs) used in collaboration sessions (referred to as “collaboration interfaces”).

During the collaboration session, the application server 116 is responsible for real-time synchronization of the collaboration data 204 between the client devices 106 and 108. The application server 116 handles the real-time synchronization using one of the established synchronization protocols such as operational transform or differential synchronization. On each of the client devices 106 and 108 a model view controller utilizes the collaboration data 204 to display the current state of the model view 206 and the interaction data 208.

The application server 116 also handles requests from the client devices 106 and 108 for freezing and committing the model view 206 to persistent storage as a data record. The freeze and commit requests may be submitted by a user of one of the client devices 106 or 108 through a collaboration interface presented on the client devices 106 and 108. Upon receiving a valid commit operation from one the client devices 106 and 108, the application server 116 causes the current state of the data record 200 as provided by the model view 206 to be stored in the database 120 (e.g., by adding an additional data record or by writing new information into the data record 200). In some embodiments, the database 120 may employ versioning of data records so as to allow restoring and comparing previous versions of data records.

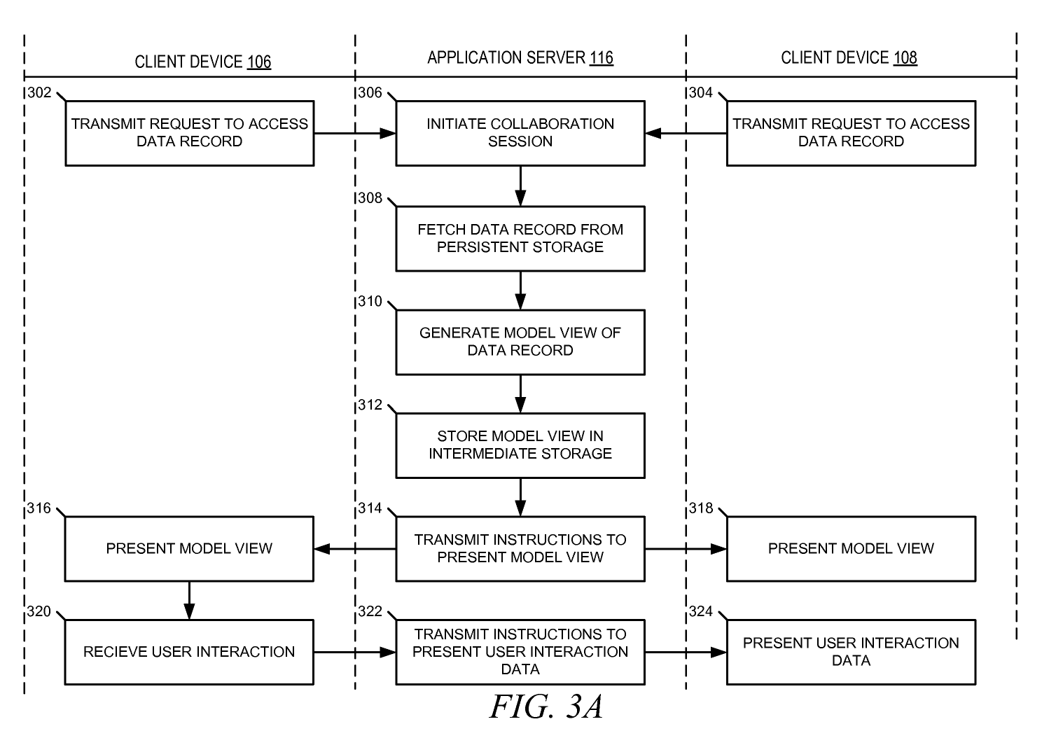

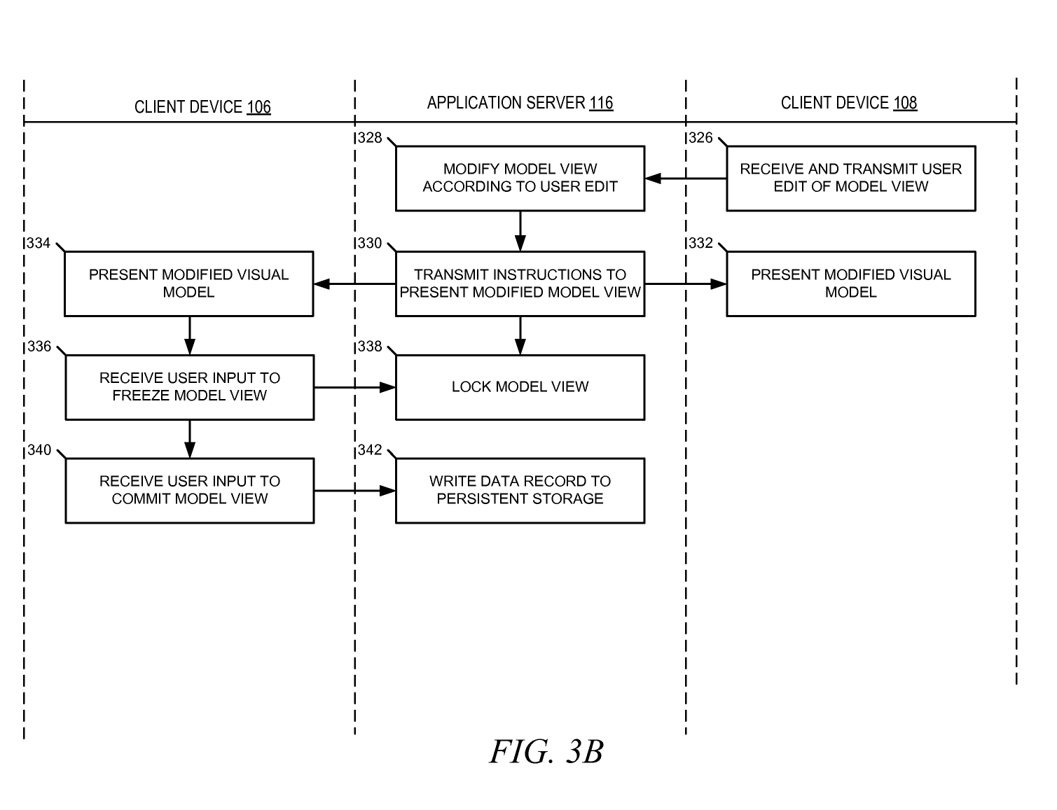

FIGS. 3A-B are interaction diagrams illustrating example exchanges between various functional components of the enterprise environment 100, according to an example embodiment. As shown, the process begins at operations 302 and 304 where the client devices 106 and 108 transmit a request to access the data record 200. Upon receiving the requests to access the data record 200, the application server 116 initiates a collaboration session between the client devices 106 and 108, at operation 306. The initiating of the collaboration session includes providing instructions to each of the client devices 106 and 108 to display a communication interface to facilitate collaborative editing and communication between the users of the client devices 106 and 108. Further, the application server 116 may begin to capture the interactions (e.g., mouse movements, state of UI elements, and chat information) of the users of the client devices 106 and 108 with the collaboration interfaces.

At operation 308, the application server 116 fetches the data record 200 from the persistent storage repository in which it is stored (e.g., database 120). At operation 310, the application server 116 generates a model view 206 of the data record 200. The model view 206 is an intermediate copy of the data record 200 that provides a visual representation of the current state of the data record 200, and in operation, functions as a draft of the data record 200. At operation 312, the application server 116 stores the model view 206 in an intermediate storage repository of the application server 116 (e.g., intermediate storage 202). At operation 314, the application server 116 transmits instructions to the client devices 106 and 108 that cause the client devices 106 and 108 to present the model view 206 in the collaboration interface.

At operations 316 and 318, the client devices 106 and 108 present the model view 206 of the data record 200, respectively. At operation 320, the client device 106 receives a user interaction (e.g., movement of a mouse cursor) within the collaboration interface displaying the model view 206, and transmits interaction data 208 indicative of said user interaction to the application server 116. At operation 322, the application server 116 transmits instructions to the client device 108 to present the user interaction data 208 of the client device 106. At operation 324, the client device 108 presents the user interaction data 208 of the client device 106. In an example, the user interaction data 208 includes movement of a mouse cursor, and accordingly, the presentation of the interaction data 208 on the client device 108 includes a display of the movement of the mouse courser of the client device 106.

Turning to FIG. 3B, at operation 326, the client device 108 receives, via the collaboration interface, a user edit to the model view 206, and transmits the user edit to the application server 116. At operation 328, the application server 116 modifies the model view 206, which is stored in intermediate storage 202, according to the received user edit. At operation 330, the application server 116 transmits instructions to the client devices 106 and 108 to present the modified model view 206. In this manner, the application server 116 ensures that the information being collaborated upon (e.g., the model view 206 of the data record 200) is synchronized between the client devices 106 and 108. At operations 332 and 334, the client devices 106 and 108 respectively present the modified model view 206.

At operation 336, the client device 106 receives user input, via the collaboration interface, to freeze the model view 206, which triggers transmission of a freeze request to the application server 116. In response to receiving the freeze request, the application server 116 locks the model view 206 in its current state, at operation 338. Users are prevented from editing the model view 206 while it is locked.

At operation 340, the client device 106 receives user input, via the collaboration interface, to commit the model view 206, which triggers transmission of a commit request to the application server 116. In response to receiving the commit request, the application server 116 writes, at operation 342, a data record representative of information contained within the current state of the model view 206 to persistent storage. In some embodiments, the application server 116 simply overwrites the data record 200, while in other embodiments, the application server 116 adds a new data record to the persistent storage so as to maintain multiple versions of the data record 200.

FIG. 4 is a block diagram illustrating various functional components of a data collaboration engine 122, which is provided as part of the collaboration platform 102, according to an example embodiment. As is understood by skilled artisans in the relevant computer and Internet-related arts, each component (e.g., a module or engine) illustrated in FIG. 4 represents a set of executable software instructions and the corresponding hardware (e.g., memory and processor) for executing the instructions.

As shown, the data collaboration engine 122 includes a request module 400, an interface module 402, a data interaction module 404 and a communication module 406, all configured to communicate with each other (e.g., via a bus, shared memory, a switch, or application programming interfaces (APIs)). The various functional components of the data collaboration engine 122 may reside on a single computer (e.g., a server), or may be distributed across several computers in various arrangements. The various components of the data collaboration engine 122 may, furthermore, access one or more databases, and each of the various components of the data collaboration engine 122 may be in communication with one another. Further, while the components of FIG. 4 are discussed in the singular sense, it will be appreciated that in other embodiments multiple instances of the components may be employed.

The request module 400 is responsible for receiving and processing client requests (e.g., requests from the client devices 106 or 108). For example, the request module 400 may be configured to receive client requests to access data records stored in the database 120. The request module 400 may also be configured to receive client requests to edit, freeze, or commit data to persistent storage. Upon receiving such client requests, the request module 400 may communicate the client requests to another module of the data collaboration engine 122 to trigger appropriate action.

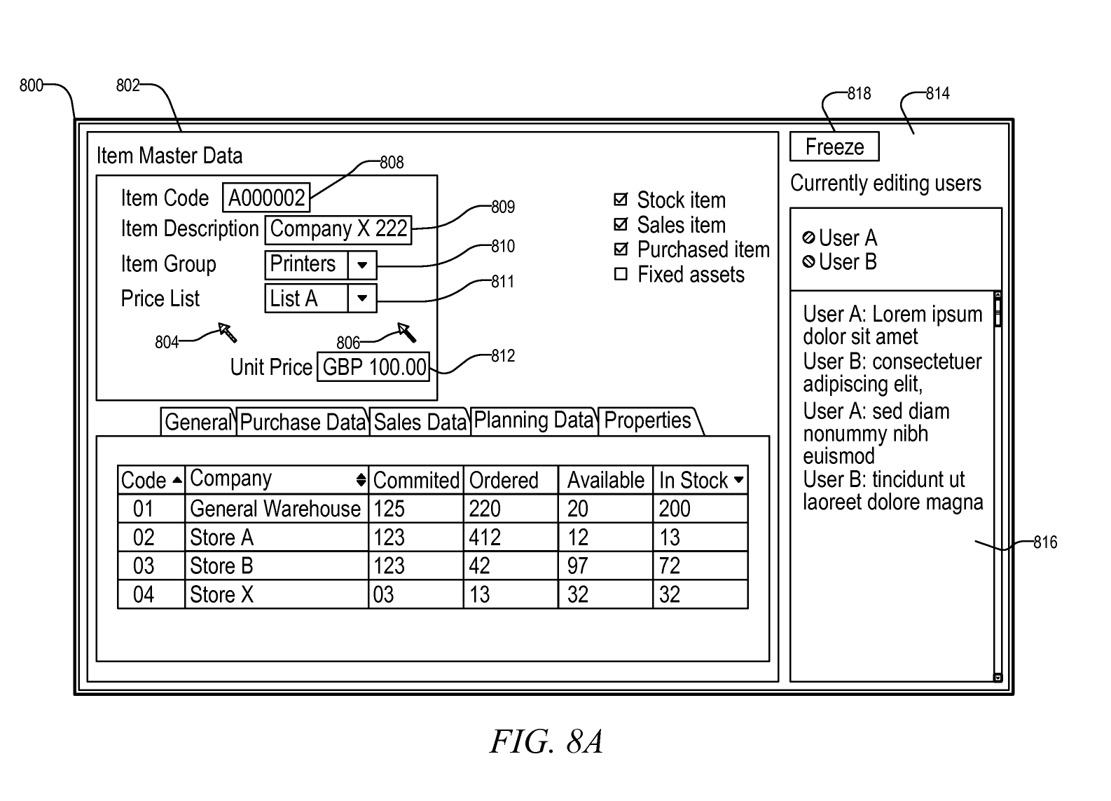

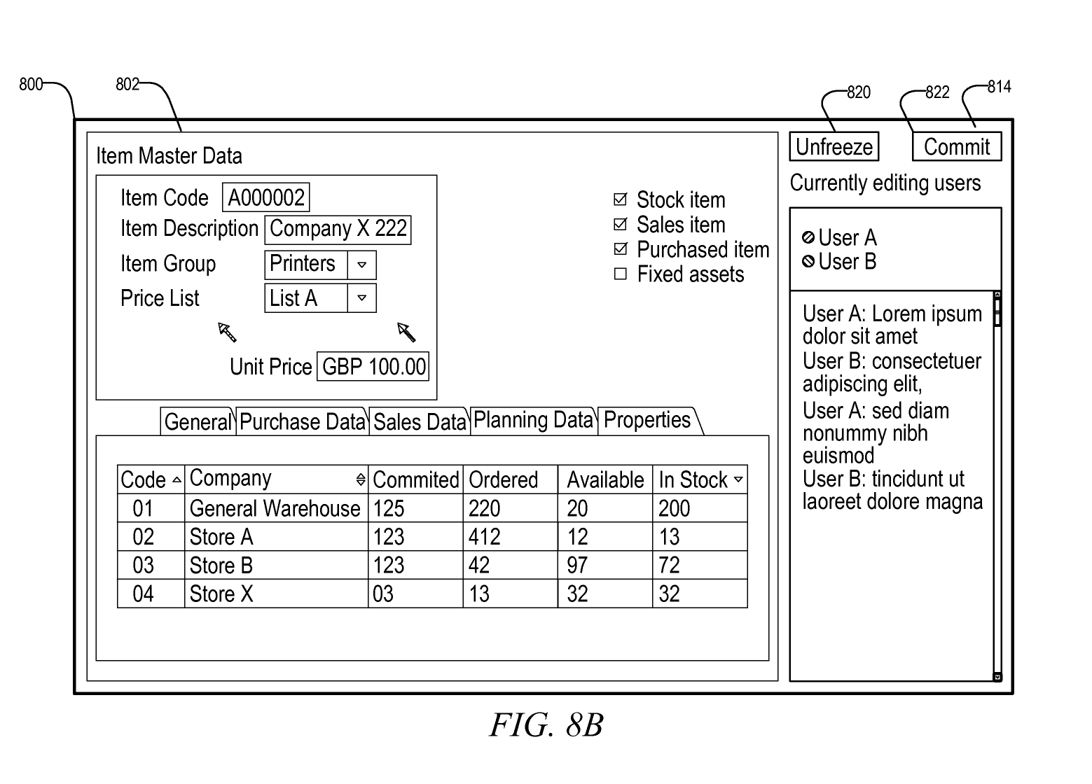

The interface module 402 is responsible for handling interactions with users of client devices involved in a collaboration session. To this end, the interface module 402 may generate and provision a number of GUIs to facilitate a collaboration session. These collaboration interfaces may include a view of data being collaborated upon (e.g., a model view of a data record stored in the database 120), a chat interface to facilitate communication between users, and a number of UI elements (e.g., buttons) that facilitate editing, freezing, and committing data. Further details of such collaboration interfaces are described below in reference to FIGS. 8A and 8B.

The data interaction module 404 is responsible for carrying out interactions with data such as creating, reading, updating and deleting (those of ordinary skill in the art may refer to these as “CRUD” operations). The data interaction module 404 may perform these data interactions upon data records stored in persistent storage (e.g., data record 200) as well as model views of data records (e.g., model view 206) stored in intermediate storage 202 of the application server 116. Consistent with some embodiments, the data interactions carried out by the data interaction module 404 may be in response to client requests received by the request module 400 via one of the interfaces provided by the interface module 402.

The communication module 406 may work in conjunction with the interface module 402 to provide collaborating users with the ability to communicate in real-time while collaborating on a data record. Accordingly, the communication module 406 may provide real-time transmission of messages from a sending user to a receiving user. The communication module 406 may employ any one of a number of known chat or instant messaging protocols (e.g., internet relay chat (IRC) or extensible messaging and presence protocol (XMPP)) to transmit messages between users.

Consistent with some embodiments, users may be provided varied levels of permission with respect to editing, freezing, and committing data (e.g., by an administrator). The permission module 408 is responsible for maintaining and enforcing user permissions related to data collaboration. In an example, the user permissions maintained by the permission module 408 may, for example, allow a user to edit data, but prevent the user from freezing or committing the data to persistent storage. In another example, the user permissions maintained by the permission module 408 may allow a user to edit and freeze data, but prevent the user from committing the data to persistent storage.

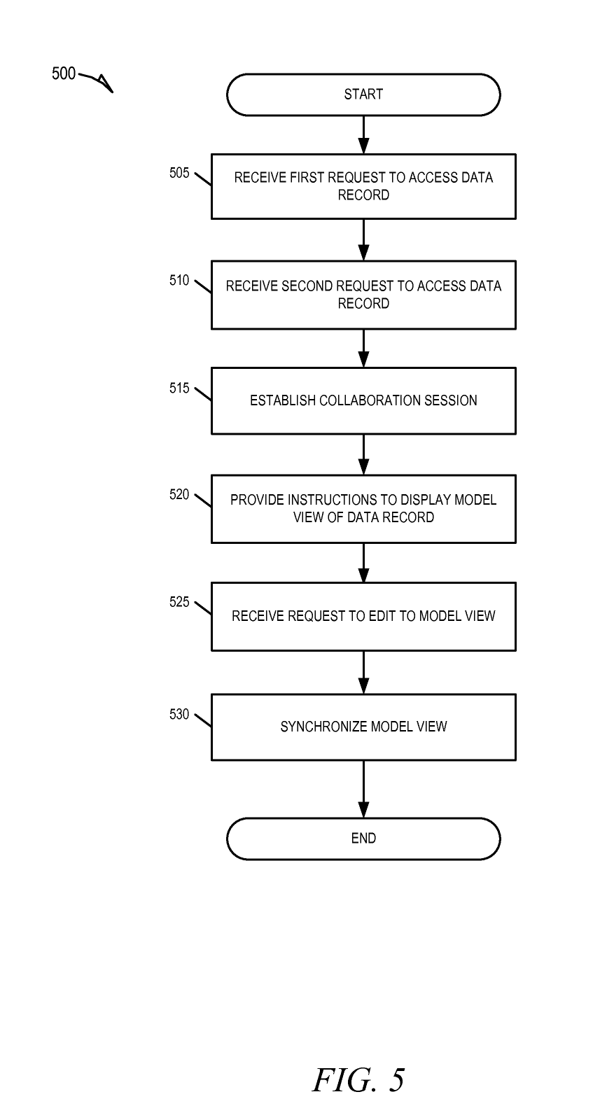

FIG. 5 is a flow chart illustrating a method 500 for managing coincidental collaboration of a data record, according to an example embodiment. The method 500 may be embodied in computer-readable instructions for execution by one or more processors such that the steps of the method 500 may be performed in part or in whole by the application server 116. More specifically, the steps of the method 500 may be performed in part or in whole by the components of the data collaboration engine 122. Accordingly, the method 500 is described below by way of example with reference thereto. However, it shall be appreciated that the method 500 may be deployed on various other hardware configurations and is not intended to be limited to the application server 116 or the data collaboration engine 122.

At operation 505, the request module 400 receives, from a first client device (e.g., client device 106), a first request to access a data record (e.g., data record 200) stored in persistent storage (e.g., the database 120). At operation 510, the request module 400 receives, from a second client device (e.g., client device 108), a second request to access the data record. In response to receiving concurrent (or near concurrent) requests to access the data record, the application server 116 establishes a collaboration session (e.g., a real-time communication link) with the two requesting client devices, at operation 515. The establishing of the collaboration session comprises providing instructions to the two requesting client devices that cause the devices to respectively display a collaboration interface (e.g., generated by the interface module 402) to facilitate collaboration between users of the two client devices. The collaboration interface may work in conjunction with the communication module 406 to provide users of the two requesting client devices means to communicate with one another via a real-time chat window. The establishing of the collaboration session further comprises collecting interaction data including the interactions of the users with the collaboration interfaces. The user interactions may include user mouse cursor positions and the state of collaboration interface elements (e.g., buttons), which may be displayed on both devices.

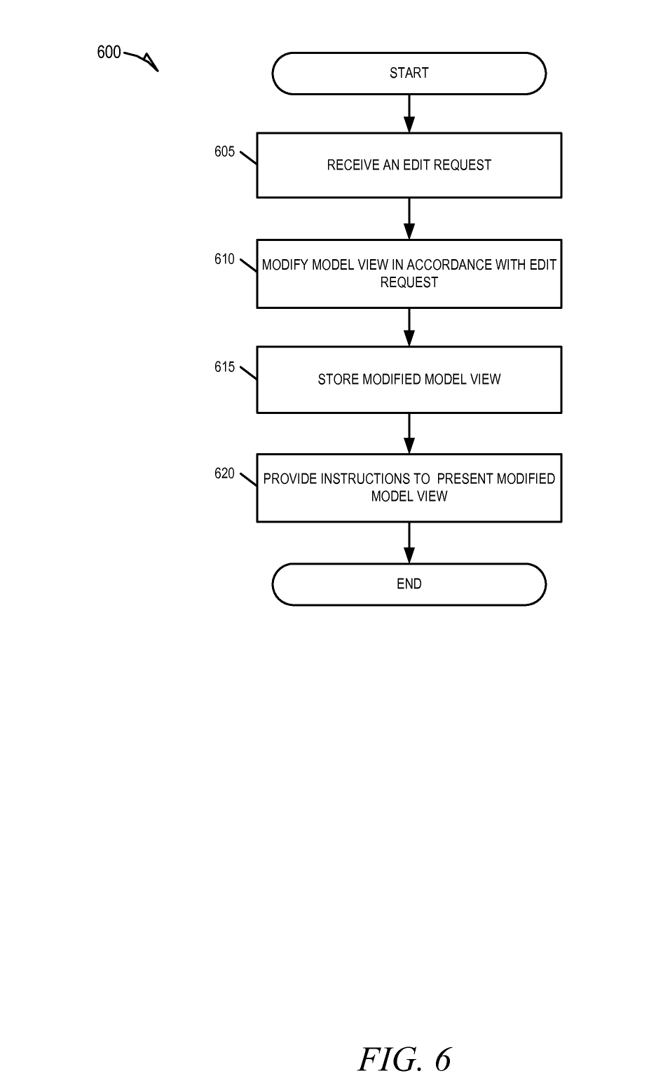

At operation 520, the interface module 402 provides instructions to the client devices (e.g., through transmission of one or more data packets) to display a model view of the data record for which the devices have requested access. The model view is a visual representation of the data record stored in an intermediate storage repository (e.g., the RAM of the application server 116) that functions as a working draft of the data record. At operation 525, the request module 400 receives a client request from one of the client devices to edit the model view (e.g., model view 206) of the data record. At operation 530, the data interaction module 404 synchronizes the model view of the data record between the two participating devices in accordance with the edit request. Further details of the synchronization between devices are discussed below in reference to FIG. 6.

FIG. 6 is a flow chart illustrating a method 600 for synchronizing a model view of a data record involved in a collaboration session, according to an example embodiment. The method 600 may be embodied in computer-readable instructions for execution by one or more processors such that the steps of the method 600 may be performed in part or in whole by the application server 116. More specifically, the steps of the method 600 may be performed in part or in whole by the components of the data collaboration engine 122. Accordingly, the method 600 is described below by way of example with reference thereto. However, it shall be appreciated that the method 600 may be deployed on various other hardware configurations and is not intended to be limited to the application server 116 or the data collaboration engine 122.

At operation 605, which may correspond to operation 525 of method 500, the request module 400 receives a request to edit a model view of a data record from one of a plurality of devices participating in a collaboration session (also referred to as “collaborating devices”) involving the data record. At operation 610, the data interaction module 404 modifies the model view in accordance with the edit request, and stores the modified model view in the intermediate storage 202 of the application server 116, at operation 615. In this way, the application server 116 may maintain a number of versions of the model view in intermediate storage before actually committing data to the persistent data repository. In other embodiments, the data interaction module 404 may edit the stored version of the model view without maintaining multiple versions. At operation 620, the interface module 402 provides instructions to the plurality of collaborating devices to present the modified model view of the data record. In this way, the application server 116 ensures that the model view presented on each of the collaborating devices is synchronized and that the model view represents the current state of the draft of the data being collaborated upon.

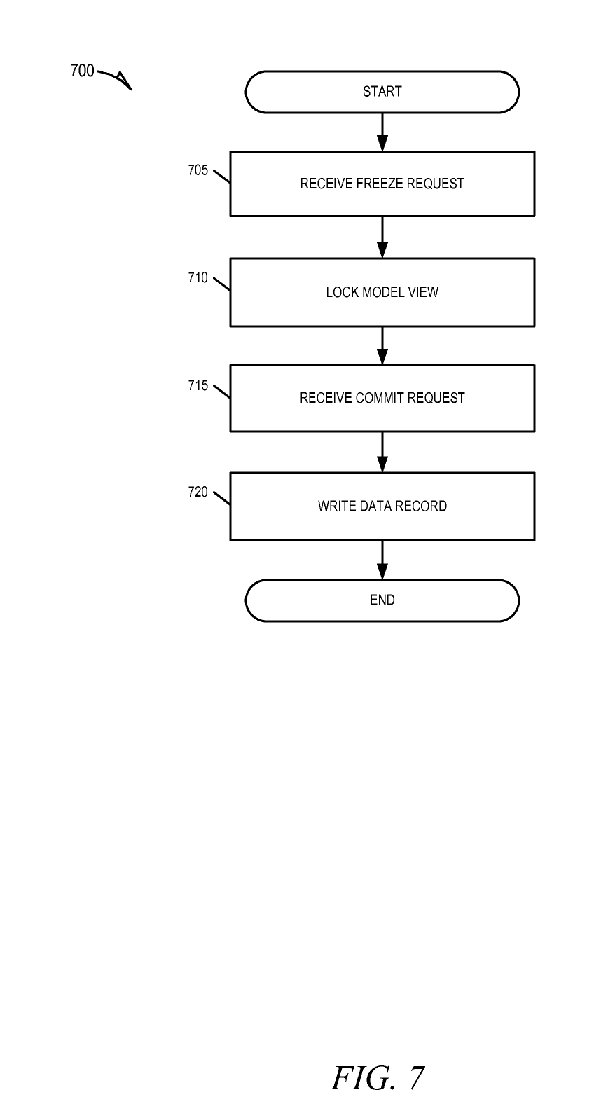

FIG. 7 is a flow chart illustrating a method 700 for synchronizing a model view of a data record involved in a collaboration session, according to an example embodiment. The method 700 may be embodied in computer-readable instructions for execution by one or more processors such that the steps of the method 700 may be performed in part or in whole by the application server 116. More specifically, the steps of the method 700 may be performed in part or in whole by the components of the coincidental data collaboration engine 122. Accordingly, the method 700 is described below by way of example with reference thereto. However, it shall be appreciated that the method 700 may be deployed on various other hardware configurations and is not intended to be limited to the application server 116 or the data collaboration engine 122

At operation 705, the request module 400 receives a request to freeze the collaboration data (e.g., the model view) from further modification. The request is received from one of a plurality of client devices participating in a collaboration session involving a data record stored in persistent storage. In response to receiving the freeze request, at operation 710, the data interaction module 404 locks the model view stored in the intermediate storage 202 of the application server 116, thus preventing any further modifications from the collaborating devices. In some embodiments, the data interaction module 404 may only act upon receipt of a valid freeze request. Accordingly, consistent with these embodiments, prior to the data interaction module 404 locking the model view, the permission module 408 determines that the request was received from a client device or is associated with a user profile that has been provided permission to freeze the data.

At operation 715, the request module 400 receives a request to commit the model view data stored in the intermediate storage 202 of the application server 116 to persistent storage (e.g., database 120). The commit request may be received from the same device that submitted the freeze request, or from any one of the other plurality of collaborating devices. In response to receiving the commit request, at operation 720, the data interaction module 404 writes a data record to persistent storage in accordance with the current state of the model view. In this way, the persistent storage may maintain a number of versions of the data record which is the subject of the communication session. In other embodiments, the data interaction module 404 may simply rewrite the data record in accordance with the current state of the model view without maintaining multiple versions. In some embodiments, the data interaction module 404 may only act upon receipt of a valid commit request. Accordingly, consistent with these embodiments, prior to the data interaction module 404 locking the model view, the permission module 408 determines that the request was received from a client device or is associated with a user profile that has been provided permission to commit the data.

FIGS. 8A-B are interface diagrams illustrating an example collaboration interface 800 and associated functionality, according to an example embodiment. As shown, the collaboration interface 800 includes a window 802 for presenting a model view of a data record involved in a collaboration session. In this example embodiment, the data record being collaborated upon corresponds to a table of data for tracking inventory and sales data. In operation, user modifications to the data presented in the window 802 result in modification to a model view of a data record rather than modification to the data record itself. The model view resides in intermediate storage 202 of the application server 116, and is not committed to persistent storage (e.g., the database 120) as a data record until a commit request is received.

As shown, the collaboration interface 800 includes cursors 804 and 806, which correspond to the respective cursor positions of the collaborating users. The application server 116 maintains the cursor positions (e.g., interaction data) along with the data entered in form fields 808-812 as part of collaboration data that is synchronized between collaborating devices during a collaboration session. In other words, the presentation of the collaboration interface 800, as illustrated in FIG. 8A, remains the same regardless of which collaborating user's device (e.g., client device 106 and 108) it is being presented on.

The collaboration interface 800 also includes a collaboration sidebar 814 having chat window 816 to facilitate real-time communication (e.g., transmission of text-based messages) between collaborating users, which are identified in the collaboration sidebar 814 as “User A” and “User B.” The chat window 816 includes a log of all messages transmitted between the collaborating users while engaged in the collaboration session.

As shown, the collaboration sidebar 814 includes button 818, which may be selected by one of the collaborating users (e.g., by clicking with a mouse or touch screen) to freeze the current state of the data presented in the window 802. Upon receiving a freeze request triggered by user selection of the button 818, the application server 116 freezes the current state of the data and prevents the collaborating users from performing further modification.

FIG. 8B illustrates the collaboration interface 800 subsequent to receiving a freeze request. As shown, the data presented in the window 802 is frozen and collaborating users are prevented from performing further modification. Further, the collaboration sidebar 814 is updated with additional buttons 820 and 822. User selection of button 820 causes the data presented in the window 802 to become unfrozen and allows collaborating users to once again modify the data presented in the window 802. User selection of the button 822 triggers transmission of a commit request and causes a data record representative of the data presented in the window 802 to be stored in persistent storage in accordance with the methodologies described herein.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Machine Architecture

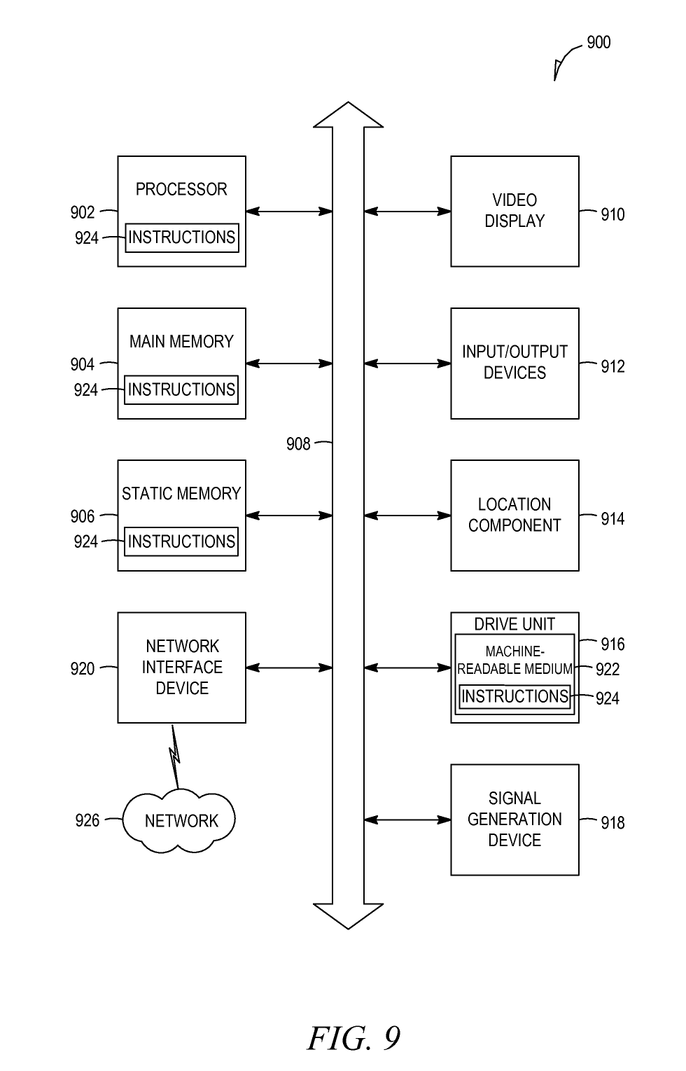

FIG. 9 is a diagrammatic representation of a machine in the example form of a computer system 900 within which a set of instructions for causing the machine to perform any one or more of the methodologies discussed herein may be executed. The computer system 900 may correspond to any one of the client devices 106 or 108, the web server 114, or the application server 116, consistent with some embodiments. The computer system 900 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine may, for example, be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display 910 (e.g., a liquid crystal display (LCD) or a cathode ray tube (CRT)). The computer system 900 also includes one or more input/output (I/O) devices 912, a location component 914, a drive unit 916, a signal generation device 918 (e.g., a speaker), and a network interface device 920. The I/O devices 912 may, for example, include a keyboard, a mouse, a keypad, a multi-touch surface (e.g., a touchscreen or track pad), a microphone, a camera, and the like.

The location component 914 may be used for determining a location of the computer system 900. In some embodiments, the location component 914 may correspond to a GPS transceiver that may make use of the network interface device 920 to communicate GPS signals with a GPS satellite. The location component 914 may also be configured to determine a location of the computer system 900 by using an internet protocol (IP) address lookup or by triangulating a position based on nearby mobile communications towers. The location component 914 may be further configured to store a user-defined location in main memory 904 or static memory 906. In some embodiments, a mobile location enabled application may work in conjunction with the location component 914 and the network interface device 920 to transmit the location of the computer system 900 to an application server or third party server for the purpose of identifying the location of a user operating the computer system 900.

In some embodiments, the network interface device 920 may correspond to a transceiver and antenna. The transceiver may be configured to both transmit and receive cellular network signals, wireless data signals, or other types of signals via the antenna, depending on the nature of the computer system 900.

### Machine-Readable Medium

The drive unit 916 includes a machine-readable medium 922 on which is stored one or more sets of data structures and instructions 924 (e.g., software) embodying or used by any one or more of the methodologies or functions described herein. The instructions 924 may also reside, completely or at least partially, within the main memory 904, the static memory 906, and/or the processor 902 during execution thereof by the computer system 900, with the main memory 904, the static memory 906, and the processor 902 also constituting machine-readable media.

Consistent with some embodiments, the instructions 924 may relate to the operations of an operating system (OS). Depending on the particular type of the computer system 900, the OS may, for example, be the iOS® operating system, the Android® operating system, a BlackBerry® operating system, the Microsoft® Windows® Phone operating system, Symbian® OS, or webOS®. Further, the instructions 924 may relate to operations performed by applications (commonly known as “apps”), consistent with some embodiments. One example of such an application is a mobile browser application that displays content, such as a web page or a user interface using a browser.

While the machine-readable medium 922 is shown in an example embodiment to be a single medium, the term “machine-readable medium” may include a single medium or multiple media (e.g., a centralized or distributed database, and/or associated caches and servers) that store the one or more data structures or instructions 924. The term “machine-readable medium” shall also be taken to include any tangible medium that is capable of storing, encoding, or carrying instructions (e.g., instructions 924) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 924 may further be transmitted or received over a network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, plain old telephone service (POTS) networks, and wireless data networks (e.g., WiFi and WiMax networks). The term “transmission medium” shall be taken to include any intangible medium that is capable of storing, encoding, or carrying the instructions 924 for execution by the machine, and includes digital or analog communications signals or other intangible media to facilitate communication of such software.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
establishing a collaboration session involving a data record accessed by at least two client devices, the data record being stored in a persistent storage repository;
providing instructions to the at least two client devices that cause display of a model view of the data record, the model view being an intermediate copy of the data record and providing an editable representation of the data record, the model view being stored in an intermediate storage repository;
receiving a user edit from one of the at least two client devices, the user edit including a modification to a portion of the model view of the data record;
modifying the model view of the data record in accordance with the user edit;
receiving, from one of the at least two client devices, a freeze request to freeze a state of the model view of the data record; and
in response to receiving the freeze request, locking the state of the model view of the data record such that the at least two client devices are unable to edit the model view.

2. The method of claim 1, further comprising:
receiving a commit request from one of the at least two client devices, the commit request to commit the modified model view of the data record to the persistent storage repository; and
in response to receiving the commit request, writing data representative of the modified model view to the persistent storage repository.

3. The method of claim 2, wherein the writing of the data representative of the modified model view includes adding a new data record to the persistent storage repository.

4. The method of claim 1, further comprising:
receiving a first request to access the data record stored in the persistent storage repository, the first request corresponding to a first client device; and
receiving a second request to access the data record stored in the persistent storage repository, the second request corresponding to a second client device,
wherein the establishing of the collaboration session is in response to receiving the first and second request to access the data record.

5. The method of claim 1, wherein the establishing of the collaboration session includes providing instructions to the at least two client devices that cause display of a collaboration interface, the collaboration interface including a chat window to facilitate real-time communication between users of the at least two client devices.

6. The method of claim 5, wherein the establishing of the collaboration session includes collecting interaction data from the at least two client devices, the interaction data relating to user interactions with the collaboration interface.

7. The method of claim 6, wherein the interaction data includes at least one of a list of collaborating users, mouse positions of the collaborating users, chat data, and states of one or more elements included in the collaboration interface.

8. The method of claim 6, further comprising synchronizing display of the interaction data on the at least two client devices.

9. The method of claim 1, wherein the modified model view is stored in the intermediate storage repository with the model view.

10. The method of claim 1, wherein the freeze request is received via a graphical user interface (GUI) for facilitating the collaboration session.

11. A system comprising:
a machine-readable persistent storage repository storing a plurality of data records;
an application server, having one or more processors, configured to establish a collaboration session involving at least one data record from the plurality of data records accessed by at least two client devices, the application server comprising:
an intermediate storage repository;
an interface module configured to provide instructions to at least two client devices that cause display of a model view of the at least one data record, the model view being an editable representation of the at least one data record, the model view being stored in the intermediate storage repository;
a data interaction module configured to modify the model view of the data record in accordance with a received user edit;
a request module configured to receive the user edit from at least one of the client devices, the request module further configured to receive, from one of the at least two client devices, a freeze request to freeze a state of the model view of the at least one data record; and
the data interaction module further configured to lock the state of the model view of the at least one data record in response to receiving the freeze request, the data interaction module to lock the state of the model view such that users of the at least two client devices are prevented from editing the state of the model view.

12. The system of claim 11, wherein the request module is further configured to receive a commit request from one of the at least two client devices, the commit request to commit the modified model view of the data record to the machine-readable persistent storage repository, wherein the data interaction module is further configured to write data to the persistent storage repository, the data being representative of the state of the model view.

13. The system of claim 12, wherein the data interaction module writes the data by editing the at least one data record of the plurality of data records.

14. The system of claim 11, wherein the request module is further configured to perform operations comprising:
receiving a first request to access the at least one data record, the first request corresponding to a first client device; and
receiving a second request to access the at least one data record, the second request corresponding to a second client device,
wherein the application server establishes the collaboration session in response to receiving the first and second request to access the data record.

15. The system of claim 11, wherein the application server establishes the collaboration session by performing operations including providing instructions to the at least two client devices that cause display of a collaboration interface, the collaboration interface including a chat window to facilitate real-time communication between users of the at least two client devices.

16. The system of claim 15, wherein the application server further comprises a communication module configured to transmit messages between the at least two client devices using a real-time chat protocol.

17. The method of claim 11, wherein the application server establishes the collaboration session by performing operations including capturing interaction data from the at least two client devices, the interaction data relating to user interactions with a graphical user interface (GUI) presented on the at least two client devices during the collaboration session.

18. The method of claim 17, wherein the interaction data includes at least one of a list of collaborating users, mouse positions of the collaborating users, chat data, and states of one or more elements included in the collaboration interface.

19. The method of claim 17, wherein the application server is further configured to synchronize display of the interaction data on the at least two client devices.

20. A tangible computer-readable storage medium including instructions that, when executed by at least one processor of a machine, cause the machine to perform operations comprising:
establishing a collaboration session involving a data record accessed by at least two client devices, the data record being stored in a persistent storage repository;
providing instructions to the at least two client devices that cause display of a model view of the data record, the model view being stored in an intermediate storage repository and providing an editable representation of the data record;
receiving a user edit from one of the at least two client devices, the user edit including a modification to a portion of the model view of the data record;
modifying the model view of the data record in accordance with the user edit;
receiving, from one of the at least two client devices, a freeze request to freeze a state of the model view of the data record; and
in response to receiving the freeze request, locking the state of the model view of the data record such that the at least two client devices are unable to edit the model view.
